(19) United States
(12) Patent Application Publication
(10) Pub. No.: US 2023/0267283 A1
(43) Pub. Date: Aug. 24, 2023

(54) SYSTEM AND METHOD FOR AUTOMATIC TEXT ANOMALY DETECTION

(71) Applicant: CONTILT LTD., HAIFA (IL)

(72) Inventors: Adi OMARI, Haifa (IL); Obaida ABU ALHIJA, Haifa (IL)

(73) Assignee: CONTILT LTD., HAIFA (IL)

(21) Appl. No.: 18/171,684

(22) Filed: Feb. 21, 2023

Related U.S. Application Data
(60) Provisional application No. 63/313,283, filed on Feb. 24, 2022.

(51) Int. Cl. G06F 40/51; G06F 40/47

(52) U.S. Cl. CPC G06F 40/51; G06F 40/47

(57) ABSTRACT

A system and method for detecting anomalies in an analyzed text may include providing features of basic elements to a descriptive language model to obtain predicted features of an examined basic element, wherein the basic elements come immediately before and/or after the examined basic element in the analyzed text, wherein the descriptive language model is trained to predict features of the examined basic element based on the features of the basic elements; and comparing the predicted features to real features of the examined basic element to detect an anomaly in the examined basic element.

### CROSS-REFERENCE TO RELATED APPLICATIONS

This application claims the benefit of U.S. Provisional Application Ser. No. 63/313,283, filed Feb. 24, 2022, which is hereby incorporated by reference in its entirety.

### FIELD OF THE INVENTION

The present invention relates generally to the field of automatic text verification and, more specifically, to anomaly detection in automatically generated or translated text.

### BACKGROUND OF THE INVENTION

Some applications require automatic text generation and text translation to many different target languages and fields. For example, some websites are required to produce millions of user and professional reviews or descriptions for thousands of products. These product reviews and product descriptions, referred to as snippets, may originate from multiple sources, written in many different source languages and should be automatically translated into a plurality of target languages. In some cases, such automated translations result in loss of quality and can lead to rendering some of these texts ineligible for use.

Therefore, it is essential to automatically assess the quality of texts, given a target language and field, and to identify and locate the problematic pieces of that text.

### SUMMARY OF THE INVENTION

A computer-based system and method for detecting anomalies in an analyzed text, the method may include, using a processor: providing features of basic elements to a descriptive language model to obtain predicted features of an examined basic element, wherein the basic elements come immediately before and/or after the examined basic element in the analyzed text, wherein the descriptive language model is trained to predict features of the examined basic element based on the features of the basic elements; and comparing the predicted features to real features of the examined basic element to detect an anomaly in the examined basic element.

Embodiments of the invention may further include extracting the features of the basic elements.

Embodiments of the invention may further include training the descriptive language model using a self-supervised training dataset.

Embodiments of the invention may further include training the descriptive language model by: obtaining a training text in a same language as the analyzed text, wherein the training text includes a plurality of training basic elements; extracting features of an investigated training basic element of the plurality of training basic elements and of training basic elements that come immediately before and/or after the investigated training basic element in the training text; providing the features of the training basic elements that come immediately before and/or after the investigated training basic element to the descriptive language model to generate predicted features of the investigated training basic element; comparing the extracted features of the investigated training basic element with the predicted features of the investigated training basic element; and adjusting the weights of the descriptive language model based on the comparison.

According to embodiments of the invention, the descriptive language model may be a neural network.

Embodiments of the invention may further include comparing the predicted features to the real features is performed by a second neural network.

Embodiments of the invention may further include generating a training dataset to the second neural network by: obtaining a training text in a same language as the analyzed text, wherein the training text includes a plurality of training basic elements; automatically labeling each of the training basic elements, together with the training basic elements coming immediately before and/or after the basic element, as being a true sample; inserting a mistake to at least one selected basic element; and labeling the at least one selected basic element, together with the training basic elements coming immediately before and/or after the selected basic element, as a false sample.

Embodiments of the invention may further include training the second neural network by: extracting features of an investigated training basic element of the plurality of training basic elements and of training basic elements that come immediately before and/or after the investigated training basic element in the training text; providing the features of the training basic elements that come immediately before and/or after the investigated training basic element to the descriptive language model to generate predicted features of the investigated training basic element; providing the predicted features and the extracted features of the investigated training basic element to the second neural network to generate predicted score of the investigated training basic element; comparing the predicted score with the label of the investigated training basic element; and adjusting the weights of the second neural network based on the comparison.

Embodiments of the invention may further include providing a second type of features of the linguistical basic elements, to a second descriptive language model, wherein the other descriptive language model is trained to predict the second type of features of the linguistical basic element based on the second type features of the linguistical basic elements; comparing the predicted second type of features to a real second type of features of the examined basic element; and unifying the results of the comparisons to detect an anomaly in the examined basic element.

### BRIEF DESCRIPTION OF THE DRAWINGS

Non-limiting examples of embodiments of the disclosure are described below with reference to figures listed below. The subject matter regarded as the invention is particularly pointed out and distinctly claimed in the concluding portion of the specification. The invention, however, both as to organization and method of operation, together with objects, features and advantages thereof, may best be understood by reference to the following detailed description when read with the accompanied drawings.

FIG. 1 presents a first anomaly detection model for detecting text anomalies, according to some embodiments of the invention.

FIG. 2 depicts a second anomaly detection model for detecting text anomalies, according to some embodiments of the invention.

FIG. 3 shows a flowchart of a method for text anomaly detection, according to some embodiments of the present invention.

FIG. 4 shows a flowchart of a method for training a descriptive language model, according to some embodiments of the present invention.

FIG. 5 shows a flowchart of a method for training a second level neural network, according to some embodiments of the present invention.

FIG. 6 shows a flowchart of a method for training a third level neural network, according to some embodiments of the present invention.

FIG. 7 shows a high-level block diagram of an exemplary computing device according to some embodiments of the present invention.

FIG. 8 depicts a first NN based anomaly detection model for detecting text anomalies, according to some embodiments of the invention.

FIG. 9 depicts a second NN based anomaly detection model for detecting text anomalies, according to some embodiments of the invention.

FIG. 10 depicts a high-level block diagram of an exemplary computing device according to some embodiments of the present invention.

It will be appreciated that, for simplicity and clarity of illustration, elements shown in the figures have not necessarily been drawn accurately or to scale. For example, the dimensions of some of the elements may be exaggerated relative to other elements for clarity, or several physical components may be included in one functional block or element. Reference numerals may be repeated among the figures to indicate corresponding or analogous elements.

### DETAILED DESCRIPTION

In the following detailed description, numerous specific details are set forth in order to provide a thorough understanding of the invention. However, it will be understood by those skilled in the art that the present invention may be practiced without these specific details. In other instances, well-known methods, procedures, and components, modules, units and/or circuits have not been described in detail so as not to obscure the invention. For the sake of clarity, discussion of same or similar features or elements may not be repeated.

Although embodiments of the invention are not limited in this regard, discussions utilizing terms such as, for example, “processing,” “computing,” “calculating,” “determining,” “establishing”, “analyzing”, “checking”, or the like, may refer to operation(s) and/or process(es) of a computer, a computing platform, a computing system, or other electronic computing device, that manipulates and/or transforms data represented as physical (e.g., electronic) quantities within the computer's registers and/or memories into other data similarly represented as physical quantities within the computer's registers and/or memories or other information non-transitory storage medium that may store instructions to perform operations and/or processes. Although embodiments of the invention are not limited in this regard, the terms “plurality” and “a plurality” as used herein may include, for example, “multiple” or “two or more”. The term set when used herein may include one or more items. Unless explicitly stated, the method embodiments described herein are not constrained to a particular order or sequence. Additionally, some of the described method embodiments or elements thereof can occur or be performed simultaneously, at the same point in time, or concurrently.

Embodiments of the invention may provide a system and method for text anomaly detection. The text may be automatically generated or automatically translated from a different language (e.g., generated or translated by a processor) or manually generated, e.g., by human user. Embodiments of the invention may use language models, referred to herein as descriptive language models (DLMs), that may capture different aspects of the language. According to embodiments of the invention, one or more DLMs, each capturing an aspect of the language, may be trained, and different combinations of these trained DLMs may be used as building blocks for a text anomaly detection model. The text anomaly detection model and the DLMs may be trained using a self-supervised method that does not require any manual annotation or labeling. According to some embodiments of the invention, the DLMs may be trained to predict the characteristics of an element in a sentence or text, based on context of the element.

According to some embodiments of the invention, the DLMs, and other components of the text anomaly detection model may be or may include a neural network (NN) model, and more specifically, a deep learning NN. A NN may include neurons and nodes organized into layers, with links between neurons transferring output between neurons. Aspects of a NN may be weighed, e.g., links may have weights, and training may involve adjusting weights. Aspects of a NN may include transfer functions, also referred to as nonlinear activation functions, e.g., an output of a node may be calculated using a transfer function. A NN may be executed and represented as formulas or relationships among nodes or neurons, such that the neurons, nodes or links are “virtual”, represented by software and formulas, where training or executing a NN is performed by for example a dedicated or conventional computer.

According to embodiments of the invention, an analyzed text may be divided into consecutive basic elements, where the basic elements may be words, letters, groups of letters, sentencepieces, sub-words, tokens or any other type of text sub-sequence. For example, if the basic elements are words, the text may be divided into consecutive words and if the basic elements are letters, the text may be divided into consecutive letters. Each of the basic elements in the text may be associated with a position, e.g., a location of the basic element in the text.

A text with n basic elements may be denoted as T=t₁, t₂, t₃, . . . , tₙ, where t₁, t₂, t₃, . . . , tₙ denote the basic elements at positions i=1, 2 . . . n. For example, taking the basic elements to be words, in the above paragraph, that will service as a sample text throughout this application, t₁, e.g., the basic element in position #1, is the word “According”, t₂, e.g., the basic element in position #2, is the word “to”, t₃, e.g., the basic element in position #3, is the word “embodiments”, etc.

According to embodiments of the invention, each of the basic elements tᵢ in a text T may be associated with one or more features describing or characterizing the basic element. For example, features of words may include, possible suffixes, possible prefixes, various types of semantic embeddings, such as word2vec, fastText, GloVe, or any other type of word vector representation, etc. The features of each basic element may be arranged in a feature vector (e.g., an ordered list of features) Features(T, i)=fᵢ₁, fᵢ₂, fᵢ₃ . . . , fᵢₘ, vᵢⱼ∈[0,1], where fᵢⱼ=P(featureⱼ|t₁) is the probability that feature j is true at location “i” in T. For example, a feature vector for possible suffixes may be feature=[ed, ing, er, tion, sion, cian, fully, est, ness, al, ary, able, ly, ment, ful, y], the feature vector of t₁ in the sample text, “According”, may be Features(sample text, 1)=0,1,0,0,0,0,0,0,0,0,0,0,0,0,0,0, since the suffix “ing” is true for “According” and other suffixes are not true, the feature vector of t₂ in the sample text, “to”, may be Features(sample text,2)=0,0,0,0,0,0,0,0,0,0,0,0,0,0,0,0, since “to” has no suffix, the feature vector of t₃ in the sample text, “embodiments”, may be Features(sample text, 1)=0,0,0,0,0,0,0,0,0,0,0,0,0,1,0,0, since the suffix “ment” is true for “embodiments” and other suffixes are not true.

According to some embodiment, at least part of the feature vectors may be designed in an automatic two-stage process. In a first stage, words from a text in a specific language may be split into multi-grams, e.g., unigrams, bigrams and/or trigrams. Next, suffixes that may be used as features for a specific language may be selected by a statistic selector that may count the occurrences of each multi-gram as a suffix and keep the most frequent multi-gram for that specific language as a feature vector for the language.

According to embodiments of the invention, the DLMs may obtain feature vectors of basic elements that are located before and/or after an examined basic element at location “i” in text T, and may predict the probability that at least one feature of the tested features is true at location “i”, or may generate a predicted feature vector for the basic element at location “i”. In a next step, the predicted feature vector may be matched or compared with the real feature vector of the examined basic element at location “i”. According to some embodiments, if the predicted feature vector matches the real feature vector it may be concluded that the examined basic element at location “i” is correct. However, if the predicted feature vector matches the real feature vector it may be concluded that the examined basic element at location “i” is incorrect or an anomaly.

According to some embodiments, the anomaly detection model may further include an ML model or a classifier, e.g., a NN, referred to herein as a second level ML model or second level model, trained to classify the matches and mismatches between the predicted feature vector and the real feature vector into a correct text or an anomaly prediction. For example, the predicted feature vector for a basic element at location “i” may be provided as input to the second level model, along with the true features of the basic element at location “i’ in the input text, and the second level model may provide a classification of the basic element.

The classification process may be repeated for all locations “i” in text T, or for all locations in text T in which correctness of the text should be verified. The basic elements that are located before and/or after a basic element at location “i” in text T may be referred to herein as the context of the basic element.

According to some embodiments, more than one pair of a DLM and associated second level model may be used for each basic element at each location “i” in text T. For example, a first DLM and associated second level model may be used for analyzing possible suffixes, a second DLM and associated second level model may be used for analyzing possible prefixes, etc. The results of the plurality of DLMs and associated second level models that are used for analyzing the correctness of a single location “i”, may be unified using any applicable method. For example, the results may be unified using a logical or mathematical function applied on the results of the different associated anomaly detection models. In some embodiments, the results of the plurality of associated anomaly detection models that are used for analyzing the correctness of a single location “i” may be unified using yet another ML model, referred to herein as a third level ML model or third level model. Combining different DLMs and second level models may enable capturing different aspects of the language, and may improve the accuracy of the anomaly detection model.

According to some embodiments, a plurality of DLMs may be connected to a single second level model that may unify the results of all the DLMs. The results of the plurality of DLMs (e.g., the predicted feature vector for a basic element at location “i”) may be provided as inputs to a single second level model, together with the true features of the basic element at location “i’ in the input text, and the second level model may provide a classification of the basic element at location “i” to correct or incorrect. In some embodiments, the second level model may provide probability of correctness (e.g., a value in a range of values that implies the level of correctness), which may be converted to either correct or incorrect by comparing to a threshold level, e.g., all values that satisfy the threshold are classified as correct and values that do not satisfy the threshold are classified as incorrect.

Some embodiments of the invention may improve the technology of automatic text generation and verification. Embodiments of the method for text anomaly detection using a combination of DLMs as disclosed herein may have several benefits over the prior art language models for anomaly detection applications. For example, embodiments of the method for text anomaly detection using a combination of DLMs may be less prone to overfitting, may be able to learn from a significantly smaller dataset, may include significantly smaller language models that are cheaper to run, and may be executable in real time. Due to their low complexity, text anomaly detection models according to embodiments of the invention may be executable over a wide range of edge devices including smartphones, and may provide results in real time.

Embodiments of the invention may include a method for unsupervised or self-supervised training method for the DLM and anomaly detections models. According to embodiments of the invention, at each stage of the training, including training the DLMs, the second level models and the third level model, including evaluating these models and selecting the best one, data sets may be produced automatically by a processor without the need for manual labeling that is required for supervised training. In addition, embodiments of the invention do not require manually writing language rules, as required by prior art language models. Since no manual dataset tagging, and no manual rules overriding or wrapping the model are needed, embodiments of the invention may enable training of models for many languages with minimal human intervention, and may reduce the speed and cost of training models.

According to embodiments of the invention, DLMs may be trained to predict the features of a basic element instead of predicting the basic element itself. For example, DLMs may be trained to predict the features of a word, instead of predicting the word itself. According to embodiments of the invention, predicting the features of a basic element is a much simpler and less computationally intensive task compared to predicting the basic element itself. Therefore, the use of DLMs that are trained to predict the features of a basic element may enable creating compact language models, relatively to prior art language models. The compact size of a DLM may enable efficient learning, e.g., training of a DLM may require a smaller dataset in comparison to prior art language models.

According to some embodiments, the anomaly detection model may include a hierarchy of NNs, where the first level in the hierarchy are the DLMs, the second level includes the second level ML model, each associated with a single DLM, and the third level includes the third level ML model. The DLMs may predict features of a basic element based on its context, the second level models may compare the predicted features with the real features of the basic element, and may provide a score indicative of the similarity, and the third level model may unify the results of the plurality of second level models, to provide a score indicative of the probability of the examined basic element being a mistake or an anomaly.

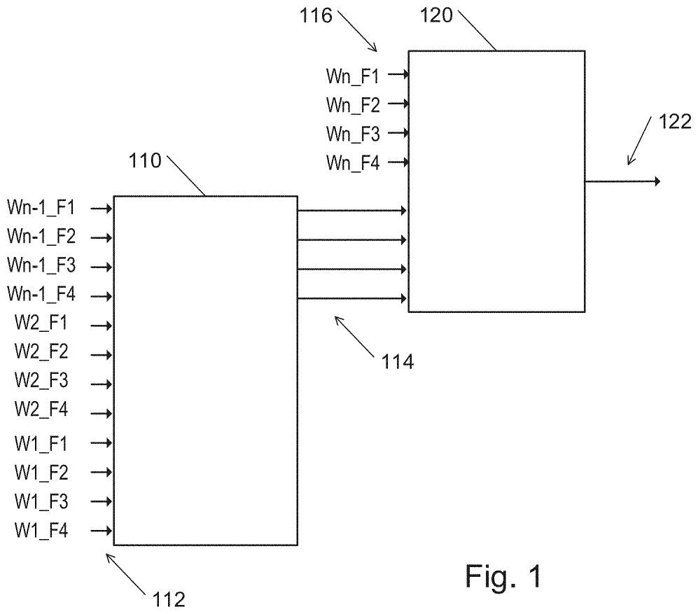

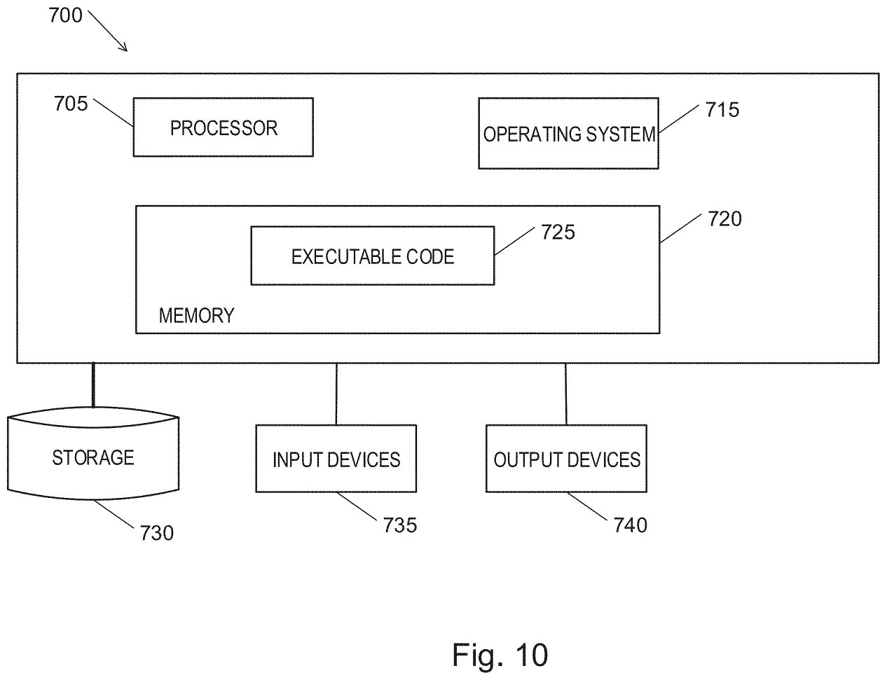

FIG. 1 depicts a first anomaly detection model 100 for detecting text anomalies, according to some embodiments of the invention. According to some embodiments of the invention, anomaly detection model 100 may include a DLM 110 and a second level model 120. DLM 110 may be or may include a neural network or other ML model, e.g., a multi label classification model such as a support vector machine based multi label classifier, k-nearest neighbors multi label classifier, etc. DLM 110 may be trained to predict features 114 of an examined basic element tₙ in a text based on feature vectors 112 of basic elements t₁, t₂, tₙ₋₁ that come immediately before and/or after (e.g., immediately precede and/or follow) the examined basic element tₙ in the text. According to embodiments of the invention, components of first anomaly detection model 100, e.g., DLM 110 and a second level model 120 may be implemented as software code, software module and/or a hardware module and executed by a processor (e.g., processor 705 depicted in FIG. 10).

In the example presented in FIG. 1, feature vectors 112 of basic elements, t₁, t₂, tₙ₋₁, that come immediately before examined basic element tₙ in a text T are provided to DLM 110. Text T may be a text that is automatically generated by a processor, or a text that was automatically translated by the processor from a source language to the target language. The features may be extracted using a feature extraction tool, e.g., sentencepiece, wordpiece, etc. While in the example provided in FIG. 1 features of basic elements that precede an examined basic element are provided to DLM 110, this is not limiting and DLM 110 may obtain, in addition or instead, features of basic elements that follow examined basic element. In the example presented in FIG. 1 each of feature vectors 112 includes four features, however this is not limiting, and other number of features may be used. For example, feature vectors 112 of t₁ includes features [t1_f1,1, t1_f1,2, t1_f1,3, t1_f1,4].

Given input feature vectors 112, DLM 110 may predict features 114 of an examined basic element tₙ in the text. Predicted features 114 may be compared with the real features 116 extracted from basic element tₙ using any applicable method. In some embodiments, predicted features 114 may be compared with the real features 116 using mathematical and/or logical rules. In some embodiments, predicted features 114 may be compared with the real features 116 using second level model 120. For example, predicted features 114, together with the real features 116, may be provided as input to second level model 120 which may provide a score indicative of whether basic element tₙ is correct or an anomaly (e.g., a mistake). Second level model 120 may be or include a NN or other multi-class classifier such as a support vector machine-based classifier, a decision tree classifier, etc.

According to embodiments of the invention, DLM 110 may be trained using a self-supervised training dataset, e.g., by a training dataset that is automatically generated by a processor. For example, the processor may obtain a training text, that is considered grammatically correct, in a language of the analyzed text. Similarly to the analyzed text T, the training text may include a plurality of consecutive basic elements. The processor may extract features of the basic elements of the training text. According to embodiments of the invention, the extracted features may be used both as input for DLM 110 during training, and as the ground truth. In each training iteration, a selected basic element from the training text may be used as an investigated basic element. In a training iteration, the features of basic elements coming immediately before and/or after the investigated basic element may be provided to DLM 110 as input. Using this input data, DLM 110 may provide or calculate a prediction of the features of the investigated basic element. The predicted features of the investigated basic element (e.g., the features generated by DLM 110 in the training iteration) may be compared with the true features of the investigated basic element, and the weights and other parameters of DLM 110 may be adjusted or tuned based on the comparison, e.g., using a backpropagation algorithm.

Furthermore, according to embodiments of the invention, second level model 120 may also be trained using a self-supervised training dataset, e.g., by a training dataset that is automatically generated by a processor. Since the training text is considered grammatically correct, each basic element in the training text may be labeled as a true sample, and may be used, together with the basic elements coming immediately before and/or after the basic element, as a true sample. False samples may be generated as follows, a mistake may be automatically and intentionally inserted to a selected basic element in the training text, e.g., the selected basic element may be replaced, changed, omitted, etc. Other methods for error introduction may be used. If the selected basic element is replaced or changed, the changed basic element, together with the original basic elements coming immediately before and/or after the original basic element may be labeled as a false sample. If the selected basic element is omitted or switched, each of the basic elements in the vicinity of the omitted or switched basic element, together with the basic elements coming immediately before and/or after those basic elements, may be labeled as a false sample.

The labeled samples, true and false, may be provided to first anomaly detection model 100, e.g., to the pair of DLM 110 and second level model 120, where DLM 110 is already trained. For example, features extracted from the basic elements in the labeled samples may be provided as input to DLM 110. In a training iteration, second level model 120 may obtain the predicted features, generated by already trained DLM 110, and the true features, and may provide a prediction or a score indicative of whether the examined basic element of the labeled sample is true (e.g., correct) or false (e.g., incorrect or an anomaly). The prediction of second level model 120 may be compared with the label of the sample, and the weights and other parameters of second level model 120 may be adjusted based on the comparison, e.g., using a backpropagation algorithm.

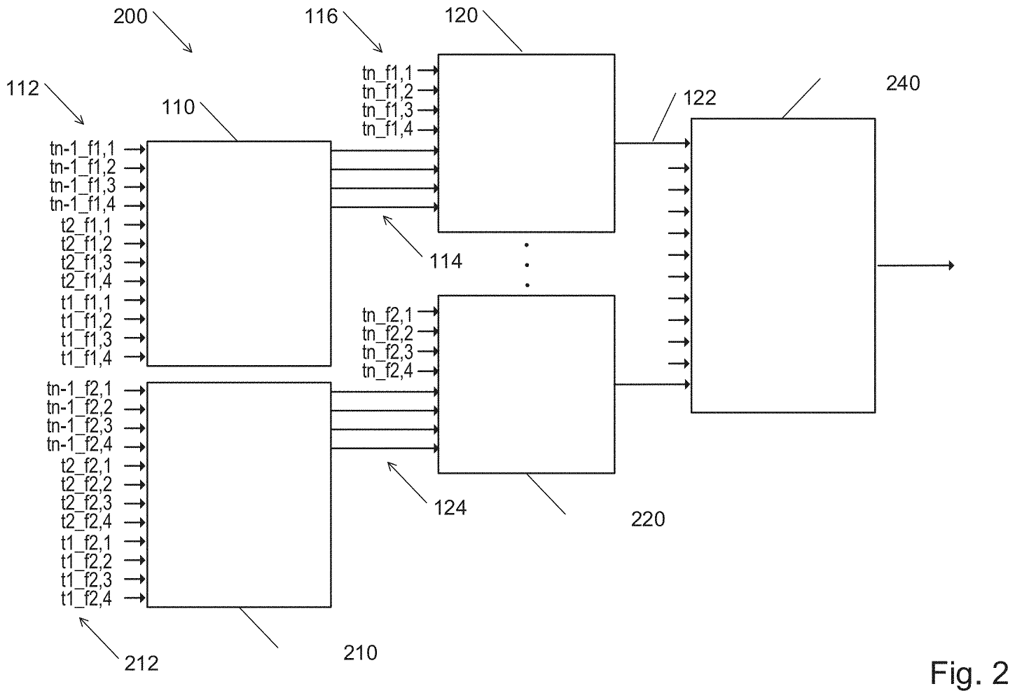

FIG. 2 depicts a second anomaly detection model 200 for detecting text anomalies, according to some embodiments of the invention. According to some embodiments of the invention, anomaly detection model 200 may be an augmentation of anomaly detection model 100, in a sense that more than one DLMs 110 and 210 may be used, each with a corresponding second level models 120 and 220. Anomaly detection model 200 may further include a third level model 240. Third level model 240 may obtain outputs of second level models 120 and 220, and may unify the results of second level model 120 and 220. Other ML models or other methods may be used to unify the results of second level models 120 and 220. For example, the results of second level models 120 and 220 may be unified by a mathematical function, logical rules, or a combination thereof.

Each of DLMs 110 and 210 may obtain a different type or a different kind of feature vectors 112 and 114, e.g., feature vectors 112 may include a first type of features (e.g., prefixes) and feature vectors 114 may include a second type pf features (e.g., suffixes). Other DLMs (not explicitly shown) may obtain additional types of feature vectors. Each of DLMs 110 and 210 may be or may include a NN or other ML model that is trained to predict features 114 and 124 of an examined basic element tₙ in a text based on feature vectors 112 and 122, respectively, of basic elements t₁, t₂, tₙ₋₁ that come immediately before and/or after (e.g., immediately precede and/or follow) the examined basic element tₙ in the text.

According to embodiments of the invention, components of first anomaly detection model 200, e.g., DLMs 110 and 210, second level models 120 and 220 and third level model 240 may be implemented as software code, software module and/or a hardware module and executed by a processor (e.g., processor 705 depicted in FIG. 10).

According to embodiments of the invention, each of DLMs 110 and 120, and each pair of a DLM and a second level model, e.g., DLMs 110 together second level model 120 and DLMs 210 together second level model 220, may be trained as disclosed herein, with reference to FIG. 1. Finally, after all the DLMs and the pairs of a DLM and a second level model are trained, the third level model 240 may be trained, using the same training set created for training second level models 120 and 220.

During training, the same labeled samples, true and false, may be provided to second anomaly detection model 200, where DLMs 110 and 210, and second level models 120 and 220 are already trained. For example, features of the first type extracted from the basic elements in the labeled samples may be provided as input to DLM 110 and features of a second type extracted from the basic elements in the labeled samples may be provided as input to DLM 210. Second level model 120, that is already trained, may obtain the predicted features generated by already trained DLM 110, and the true features of the first type, and may provide a prediction or a score indicative of whether the examined basic element of the labeled sample is true (e.g., correct) or false (e.g., incorrect or an anomaly). Similarly, second level model 220, that is already trained, may obtain the predicted features generated by already trained DLM 210, and the true features of the second type, and may provide a prediction or a score indicative of whether the examined basic element of the labeled sample is true (e.g., correct) or false (e.g., incorrect or an anomaly). In a training iteration, third level model 240 may obtain the scores, generated by already trained second level models 120 and 220, and the true label, and may provide a prediction or a final score indicative of whether the examined basic element of the labeled sample is true (e.g., correct) or false (e.g., incorrect or an anomaly). The prediction of third level model 240 may be compared with the label of the sample, and the weights and other parameters of third model 240 may be adjusted based on the comparison, e.g., using a backpropagation algorithm. Other training methods may be used, for example, second level models 120 and 220 and third level model 240 may be jointly trained or trained together.

It should be readily understood to those skilled in the art, that a single second level model 120 may obtain predicted features from more than one DLM 110 and may be trained as disclosed herein together with all the DLMs that provide inputs to the second level model 120.

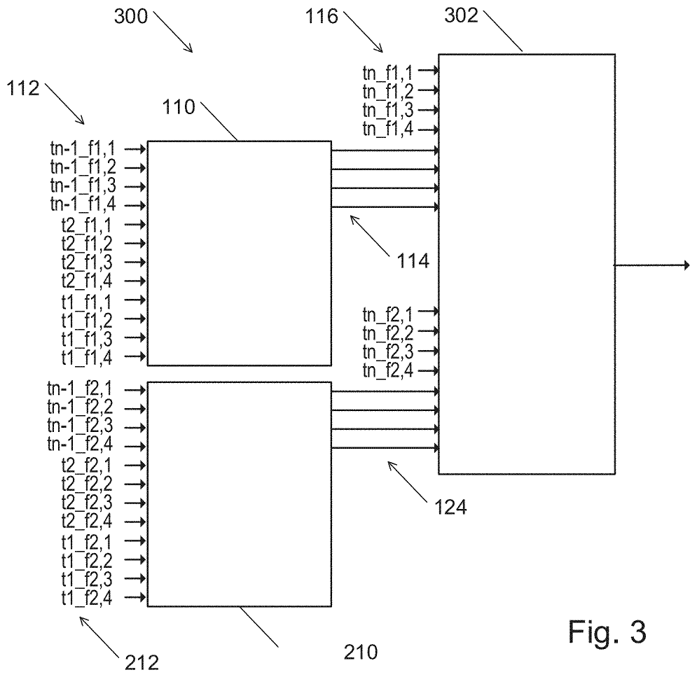

FIG. 3 depicts a third anomaly detection model 300 for detecting text anomalies, according to some embodiments of the invention. According to some embodiments of the invention, anomaly detection model 300 may be an augmentation of anomaly detection model 100, in a sense that more than one DLMs 110 and 210 may be used, with a single second level model 302. According to some embodiments, single second level model 302 may compare the features predicted by DLMs 110 and 210 and unify the results of the comparison. Second level model 302 may include a NN or other ML classification model and may be implemented as software code, software module and/or a hardware module and executed by a processor (e.g., processor 705 depicted in FIG. 10).

According to embodiments of the invention, each of DLMs 110 and 210 may be trained as disclosed herein, with reference to FIG. 1. After all the DLMs are trained, second level model 302 may be trained, using the same training set created for training second level models 120 and 220. During training, the same labeled samples, true and false, may be provided to third anomaly detection model 300, where DLMs 110 and 210 are already trained. For example, features of the first type extracted from the basic elements in the labeled samples may be provided as input to DLM 110 and features of a second type extracted from the basic elements in the labeled samples may be provided as input to DLM 210. Single second level model 302 may obtain the predicted features, generated by already trained DLMs 110 and 210, the true features, and the true label, and may provide a prediction or a final score indicative of whether the examined basic element of the labeled sample is true (e.g., correct) or false (e.g., incorrect or an anomaly). The prediction of single second level model 302 may be compared with the label of the sample, and the weights and other parameters of single second level model 302 may be adjusted based on the comparison, e.g., using a backpropagation algorithm. Other training methods may be used.

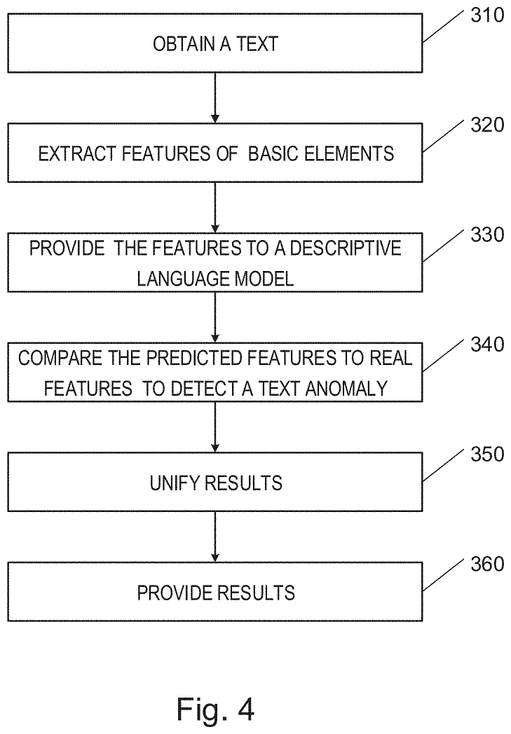

FIG. 4 shows a flowchart of a method for text anomaly detection, according to some embodiments of the present invention. The operations of FIG. 4 may be performed by the systems described in FIG. 10, but other systems may be used.

In operation 310, a processor (e.g., processor 705 in FIG. 10) may obtain a text for analysis. The text may be automatically generated or automatically translated from a different language. The text may include or may be composed of consecutive basic elements, where the basic elements may be words, letters, groups of letters, etc. In operation 320, the processor may extract features of the basic elements. The features of each basic element may be arranged in one or more feature vectors associated with the basic element. For example, each type of features may be arranged in a single feature vector. In operation 330, the processor may provide feature vectors (e.g., a subgroup or all the features) of basic elements that come immediately before and/or after an examined basic element in the analyzed text, to a text anomaly detection model.

According to some embodiment, the text anomaly detection model may include a hierarchy of two or more ML models, e.g., NNs, wherein the first hierarchy includes one or more DLM. Each of the DLMs may be trained to provide predicted features (of the same type that is provided to that DLM) of the examined basic element, based on the features of the basic elements. In some embodiments, the DLM may be or may include a NN. In operation 340, the processor may compare the predicted features to real features of the examined basic element, to detect an anomaly in the examined basic element. For example, the output of each of the DLMs may be provided to one or more second level ML model or NN, that may compare the predicted features to real features of the examined basic element, to detect an anomaly in the examined basic element. In some embodiments, a single DLM and a single a second level ML model may be used. In some embodiments, a plurality of pairs of a DLM and a second level ML model or NN are used. In some embodiments, a plurality of DLMs and a single second level ML model may be used, in some embodiments, the processor may compare the predicted features to real features using logical and/or mathematical rules.

In case a plurality of pairs of a DLM and a second level ML model or NN are used, the results of the plurality of pairs of a DLM and a second level ML model or NN may be unified, e.g., using a third level ML model or NN, as indicate in optional operation 350. In operation 360, the processor may provide the results of the text anomaly detection model to a user and/or to the software application. For example, the processor may provide the results to an application that may amend the text in the places indicated in operation 360. In some embodiment, the corrected text may be reexamined.

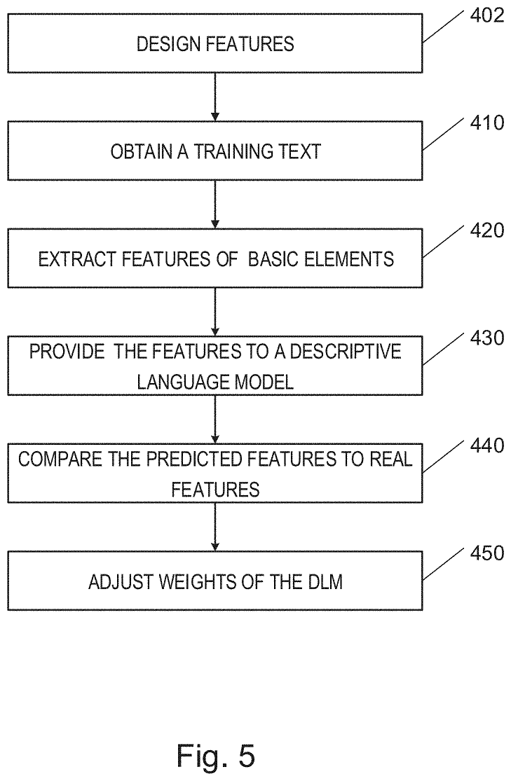

FIG. 5 shows a flowchart of a method for training a DLM, according to some embodiments of the present invention. The operations of FIG. 4 may be performed by the systems described in FIG. 10, but other systems may be used. Embodiments of the method for training a DLM may be self-supervised in a sense that the training samples are automatically generated, e.g., by a processor (e.g., processor 705 in FIG. 10).

In a preparation operation 402, feature vectors for a DLM may be designed for the language of the analyzed text. In some embodiments, the feature vectors may be designed in an automatic two-stage process. In a first stage, words from a text or a corpus of tests in the same language as the analyzed text may be split into multi-grams, e.g., unigrams, bigrams and/or trigrams. Next, suffixes that may be used as features for a specific language may be selected by a statistic selector that may count the occurrences of each multi-gram as a suffix and keep the most frequent multi-gram for that specific language as a feature vector for the language.

In operation 410, the processor may obtain a training text in the same language as the analyzed text. The training text may include a plurality of training basic elements of the same type as the analyzed text. In operation 420, the processor may generate training samples for the trained DLM from the training text. For example, the processor may generate a training sample by extracting features of an investigated training basic element and of training basic elements that come immediately before and/or after the investigated training basic element in the training text. The features of an investigated training basic element, together with the features of the training basic elements that come immediately before and/or after the investigated training basic element may form a training sample, and a plurality of samples may be generated from a single text and/or from a plurality of training texts. Returning to the sample text, a first example of a training sample may include features extracted from the basic element in position #6 (e.g., “invention”), and features extracted from five basic elements that precede the basic element in position #6 (e.g., “According”, “to”, “embodiments”, “of” and “the”). A second example of a training sample may include features extracted from the basic element in position #7 (e.g., “an”), and features extracted from five basic elements that precede the basic element in position #6 (e.g., “to”, “embodiments”, “of”. “the” and “invention”). Thus, a plurality of training samples may be extracted from a single text.

In operation 430, the processor may provide the training sample, e.g., the features of the training basic elements that come immediately before and/or after the investigated training basic element, to the trained DLM, and the trained DLM may generate or calculate predicted features of the investigated training basic element. For example, if the first example of a training sample is provided to a DLM, the DLM may predict features of a basic element in position #6 (not the basic element itself, only the features of the basic element).

In operation 440, the processor may compare the extracted features of the investigated training basic element with the predicted features of the investigated training basic element. For example, the processor may compare the features extracted from “invention” with the predicted features of a basic element in position #6. In operation 450, the processor may adjust the weights of the trained DLM based on the comparison, e.g., using a backpropagation algorithm.

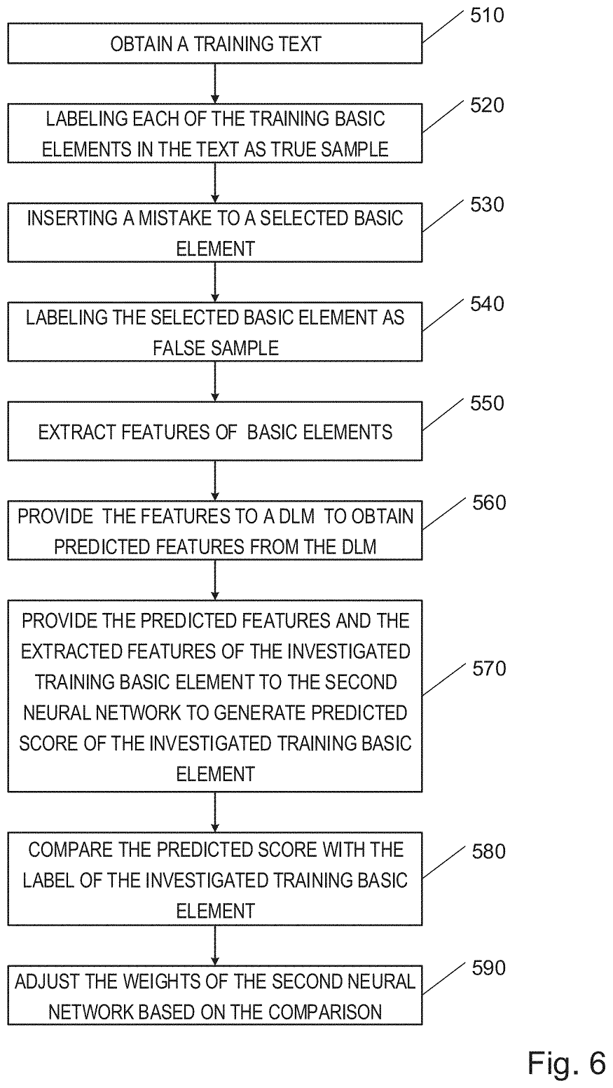

FIG. 6 shows a flowchart of a method for training a second level model, according to some embodiments of the present invention. The operations of FIG. 6 may be performed by the systems described in FIG. 10, but other systems may be used. Embodiments of the method for training a second level model may be self-supervised in a sense that the training samples are automatically generated, e.g., by a processor (e.g., processor 705 in FIG. 10).

In operation 510, the processor may obtain a training text in the same language as the analyzed text. The training text may include a plurality of training basic elements of the same type as the analyzed text. In operation 520, the processor may automatically label each of the training basic elements, together with the training basic elements coming immediately before and/or after the basic element, as being a true sample. For example, in the sample text, the basic element in position #6 (“invention”), together with the five basic elements that precede the basic element in position #6 (e.g., “According”, “to”, “embodiments”, “of” and “the”) may be labeled as a true sample. A plurality of true samples may be generated from one or more training texts.

In operation 530, the processor may insert a mistake in at least one selected basic element. For example, in the sample text, the basic element in position #6 (“invention”) may be changed deliberately to “invented”. In operation 540, the processor may label the changed basic element, together with the training basic elements coming immediately before and/or after the changed basic element, as a false sample. For example, in the sample text, the changed basic element in position #6 (“invented”), together with the five basic elements that precede the basic element in position #6 (e.g., “According”, “to”, “embodiments”, “of” and “the”) may be labeled as a false sample. A plurality of false samples may be generated from one or more training texts.

In operation 550, the processor may extract features of an investigated training basic element of the plurality of training basic elements that come immediately before and/or after the investigated training basic element in the training text. For example, the processor may extract features of true sample including the basic element in position #6 (“invention”), and of the five basic elements that precede the basic element in position #6 (e.g., “According”, “to”, “embodiments”, “of” and “the”). The processor may further extract features of false sample including the changed basic element in position #6 (“invented”), and of the five basic elements that precede the basic element in position #6 (e.g., “According”, “to”, “embodiments”, “of” and “the”).

In operation 560, the processor may provide the features of the training basic elements that come immediately before and/or after the investigated training basic element to a trained DLM associated with the trained second level model to generate or calculate predicted features of the investigated training basic element. For example, the processor may provide features of the true sample including the basic element in position #6 (“invention”), and of the five basic elements that precede the basic element in position #6 (e.g., “According”, “to”, “embodiments”, “of” and “the”) to the trained DLM. The trained DLM may generate the predicted features of the basic element in position #6.

In operation 570, the processor may provide the predicted or calculated features and the extracted features of the investigated training basic element to the second level model to generate or calculate predicted score of the investigated training basic element, the predicted score indicative of whether the investigated training basic element is true (e.g., correct) or false (incorrect or an anomaly). For example, the processor may provide the predicted features of the basic element in position #6 to the second level model. The second level model may generate or calculate a predicted score of the basic element in position #6.

In operation 580, the processor may compare the predicted score with the label of the investigated training basic element. For example, the processor may compare the score of the basic element in position #6 with the label of the training sample (e.g., true). In operation 590, the processor may adjust the weights of the second level model based on the comparison. e.g., using a backpropagation algorithm.

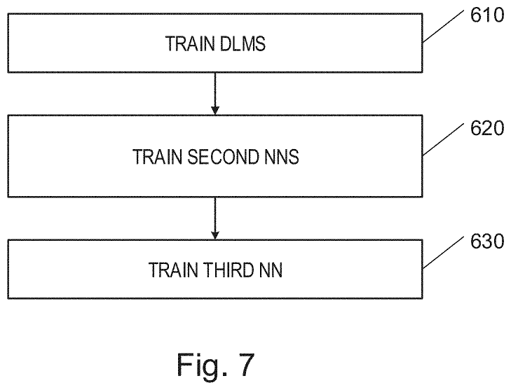

FIG. 7 shows a flowchart of a method for training a third level model, according to some embodiments of the present invention. The operations of FIG. 7 may be performed by the systems described in FIG. 10, but other systems may be used. Embodiments of the method for training a third level model may be self-supervised in a sense that the training samples are automatically generated, e.g., by a processor (e.g., processor 705 in FIG. 10).

In operation 610, the processor may train a plurality of DLMs, e.g., DLMs 110 and 210 depicted in FIG. 2. The processor may train each of the plurality of DLMs as disclosed herein, e.g., with reference to FIG. 5. In operation 620, the processor may train a plurality of second level models, each associated with a DLM, e.g., second level models 120 and 220 depicted in FIG. 2. The processor may train each of the plurality of second level models as disclosed herein, e.g., with reference to FIG. 6. In operation 630, the processor may train the third level model, e.g., as disclosed herein with reference to FIG. 2.

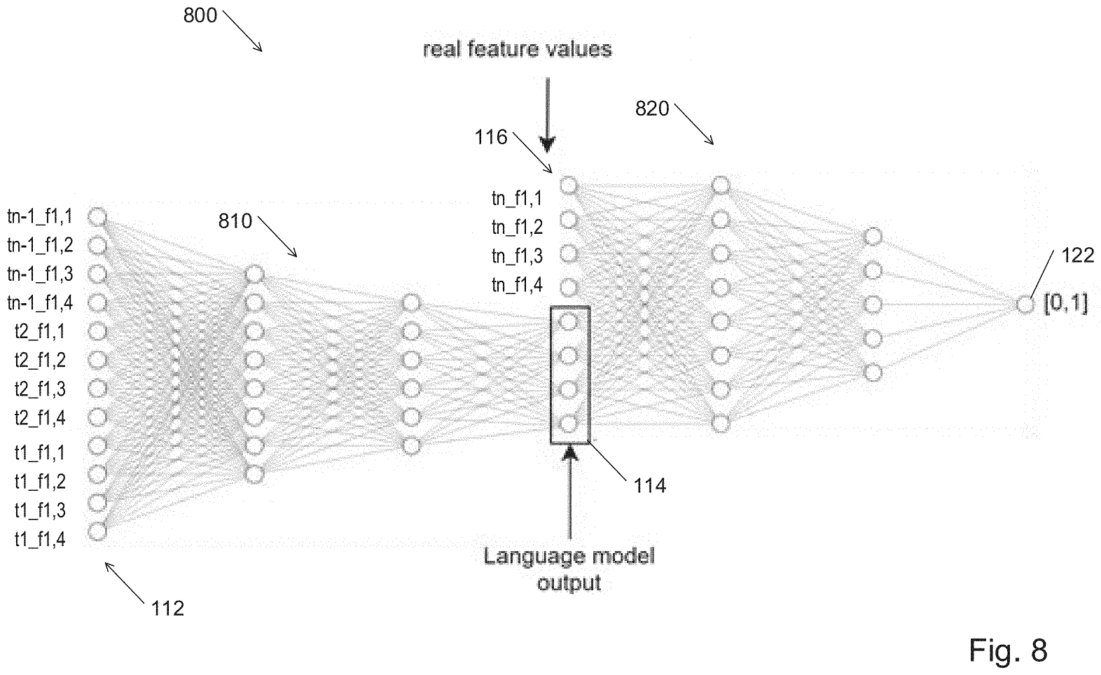

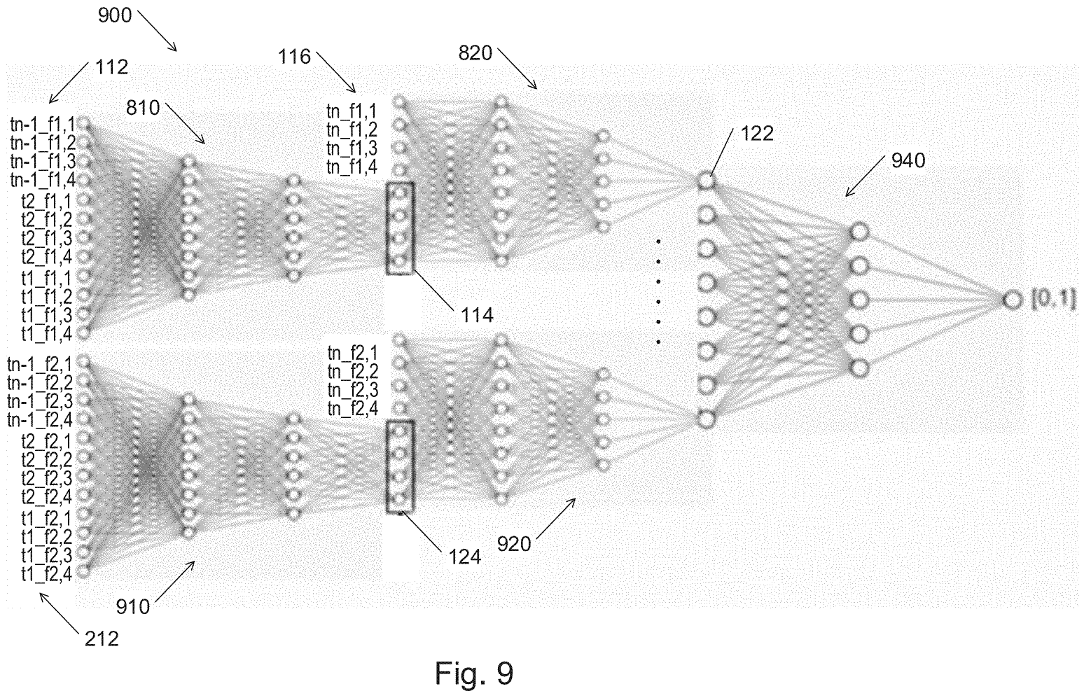

FIGS. 8 and 9 present examples of implementing anomaly detection model 100 and anomaly detection model 200 using NNs. FIG. 8 depicts a first NN based anomaly detection model 800 for detecting text anomalies, according to some embodiments of the invention. According to some embodiments of the invention, NN based anomaly detection model 800 may be an implementation of anomaly detection model 100, using NNs 810 and 920 as DLM 110 and second level model 120, respectively. FIG. 9 depicts a second NN based anomaly detection model 900 for detecting text anomalies, according to some embodiments of the invention. According to some embodiments of the invention, NN based anomaly detection model 900 may be an implementation of anomaly detection model 200, using NNs 810 and 910 for DLMs 110 and 210, respectively, NNs 820 and 920 as second level models 120 and 220, respectively, and NN 930 as third level model 240.

Reference is made to FIG. 10, showing a high-level block diagram of an exemplary computing device according to some embodiments of the present invention. Computing device 700 may include a processor 705 that may be, for example, a central processing unit processor (CPU) or any other suitable multi-purpose or specific processors or controllers, a chip or any suitable computing or computational device, an operating system 715, a memory 120, executable code 725, a storage system 730, input devices 735 and output devices 740. Processor 705 (or one or more controllers or processors, possibly across multiple units or devices) may be configured to carry out methods described herein, and/or to execute or act as the various modules, units, etc. For example when executing code 725. More than one computing device 700 may be included in, and one or more computing devices 700 may be, or act as the components of, a system according to embodiments of the invention. Various components, computers, and modules of FIGS. 1 and 2 may implemented by devices such as computing device 700, and one or more devices such as computing device 700 may carry out functions such as those described in FIGS. 3-6.

Operating system 715 may be or may include any code segment (e.g., one similar to executable code 725) designed and/or configured to perform tasks involving coordination, scheduling, arbitration, controlling or otherwise managing operation of computing device 700, for example, scheduling execution of software programs or enabling software programs or other modules or units to communicate.

Memory 720 may be or may include, for example, a Random Access Memory (RAM), a read only memory (ROM), a Dynamic RAM (DRAM), a Synchronous DRAM (SD-RAM), a double data rate (DDR) memory chip, a Flash memory, a volatile memory, a non-volatile memory, a cache memory, a buffer, a short term memory unit, a long term memory unit, or other suitable memory or storage units. Memory 720 may be or may include a plurality of, possibly different memory units. Memory 720 may be a computer or processor non-transitory readable medium, or a computer non-transitory storage medium, e.g., a RAM.

Executable code 725 may be any executable code, e.g., an application, a program, a process, task or script. Executable code 725 may be executed by processor 705 possibly under control of operating system 715. For example, executable code 725 may configure processor 705 to detect anomalies in an analyzed text, and perform other methods as described herein. Although, for the sake of clarity, a single item of executable code 725 is shown in FIG. 7, a system according to some embodiments of the invention may include a plurality of executable code segments similar to executable code 725 that may be loaded into memory 720 and cause processor 705 to carry out methods described herein.

Storage system 730 may be or may include, for example, a hard disk drive, a CD-Recordable (CD-R) drive, a Blu-ray disk (BD), a universal serial bus (USB) device or other suitable removable and/or fixed storage unit. Data such as weights and other parameters of DLMs 110 and 210, second level model 120 and 220 and third level model 240, may be stored in storage system 730 and may be loaded from storage system 730 into memory 720 where it may be processed by processor 705. Some of the components shown in FIG. 7 may be omitted. For example, memory 720 may be a non-volatile memory having the storage capacity of storage system 730. Accordingly, although shown as a separate component, storage system 730 may be embedded or included in memory 720.

Input devices 735 may be or may include a mouse, a keyboard, a microphone, a touch screen or pad or any suitable input device. Any suitable number of input devices may be operatively connected to computing device 700 as shown by block 735. Output devices 740 may include one or more displays or monitors, speakers and/or any other suitable output devices. Any suitable number of output devices may be operatively connected to computing device 700 as shown by block 740. Any applicable input/output (I/O) devices may be connected to computing device 700 as shown by blocks 735 and 740. For example, a wired or wireless network interface card (NIC), a printer, a universal serial bus (USB) device or external hard drive may be included in input devices 735 and/or output devices 740.

In some embodiments, device 700 may include or may be, for example, a personal computer, a desktop computer, a laptop computer, a workstation, a server computer, a network device, a smartphone or any other suitable computing device. A system as described herein may include one or more devices such as computing device 700.

When discussed herein, “a” computer processor performing functions may mean one computer processor performing the functions or multiple computer processors or modules performing the functions; for example, a process as described herein may be performed by one or more processors, possibly in different locations.

In the description and claims of the present application, each of the verbs, “comprise”, “include” and “have”, and conjugates thereof, are used to indicate that the object or objects of the verb are not necessarily a complete listing of components, elements or parts of the subject or subjects of the verb. Unless otherwise stated, adjectives such as “substantially” and “about” modifying a condition or relationship characteristic of a feature or features of an embodiment of the disclosure, are understood to mean that the condition or characteristic is defined to within tolerances that are acceptable for operation of an embodiment as described. In addition, the word “or” is considered to be the inclusive “or” rather than the exclusive or, and indicates at least one of, or any combination of items it conjoins.

Descriptions of embodiments of the invention in the present application are provided by way of example and are not intended to limit the scope of the invention. The described embodiments comprise different features, not all of which are required in all embodiments. Embodiments comprising different combinations of features noted in the described embodiments, will occur to a person having ordinary skill in the art. Some elements described with respect to one embodiment may be combined with features or elements described with respect to other embodiments. The scope of the invention is limited only by the claims.

While certain features of the invention have been illustrated and described herein, many modifications, substitutions, changes, and equivalents may occur to those skilled in the art. It is, therefore, to be understood that the appended claims are intended to cover all such modifications and changes as fall within the true spirit of the invention.

1. A method for detecting anomalies in an analyzed text, the method comprising, using a processor:
providing features of basic elements to a descriptive language model to obtain predicted features of an examined basic element, wherein the basic elements come immediately before and/or after the examined basic element in the analyzed text, wherein the descriptive language model is trained to predict features of the examined basic element based on the features of the basic elements; and
comparing the predicted features to real features of the examined basic element to detect an anomaly in the examined basic element.

2. The method of claim 1, comprising extracting the features of the basic elements.

3. The method of claim 1, comprising training the descriptive language model using a self-supervised training dataset.

4. The method of claim 1, comprising training the descriptive language model by:
obtaining a training text in a same language as the analyzed text, wherein the training text includes a plurality of training basic elements;
extracting features of an investigated training basic element of the plurality of training basic elements and of training basic elements that come immediately before and/or after the investigated training basic element in the training text;
providing the features of the training basic elements that come immediately before and/or after the investigated training basic element to the descriptive language model to generate predicted features of the investigated training basic element;
comparing the extracted features of the investigated training basic element with the predicted features of the investigated training basic element; and
adjusting the weights of the descriptive language model based on the comparison.

5. The method of claim 1, wherein the descriptive language model is a neural network.

6. The method of claim 5, wherein comparing the predicted features to the real features is performed by a second neural network.

7. The method of claim 6, comprising generating a training dataset to the second neural network by:
obtaining a training text in a same language as the analyzed text, wherein the training text includes a plurality of training basic elements;
automatically labeling each of the training basic elements, together with the training basic elements coming immediately before and/or after the basic element, as being a true sample;
inserting a mistake to at least one selected basic element; and
labeling the at least one selected basic element, together with the training basic elements coming immediately before and/or after the selected basic element, as a false sample.

8. The method of claim 7, comprising training the second neural network by:
extracting features of an investigated training basic element of the plurality of training basic elements and of training basic elements that come immediately before and/or after the investigated training basic element in the training text;
providing the features of the training basic elements that come immediately before and/or after the investigated training basic element to the descriptive language model to generate predicted features of the investigated training basic element;
providing the predicted features and the extracted features of the investigated training basic element to the second neural network to generate predicted score of the investigated training basic element;
comparing the predicted score with the label of the investigated training basic element; and
adjusting the weights of the second neural network based on the comparison.

9. The method of claim 1, comprising:
providing a second type of features of the linguistical basic elements, to a second descriptive language model, wherein the other descriptive language model is trained to predict the second type of features of the linguistical basic element based on the second type features of the linguistical basic elements;
comparing the predicted second type of features to a real second type of features of the examined basic element; and
unifying the results of the comparisons to detect an anomaly in the examined basic element.

10. A system for providing localization, the system comprising:
a memory; and
a processor configured to:
provide features of basic elements to a descriptive language model to obtain predicted features of an examined basic element, wherein the basic elements come immediately before and/or after the examined basic element in the analyzed text, wherein the descriptive language model is trained to predict features of the examined basic element based on the features of the basic elements; and
compare the predicted features to real features of the examined basic element to detect an anomaly in the examined basic element.

11. The system of claim 10, wherein the processor is configured to extract the features of the basic elements.

12. The system of claim 10, wherein the processor is configured to train the descriptive language model using a self-supervised training dataset.

13. The system of claim 10, wherein the processor is configured to train the descriptive language model by:
obtaining a training text in a same language as the analyzed text, wherein the training text includes a plurality of training basic elements;
extracting features of an investigated training basic element of the plurality of training basic elements and of training basic elements that come immediately before and/or after the investigated training basic element in the training text;
providing the features of the training basic elements that come immediately before and/or after the investigated training basic element to the descriptive language model to generate predicted features of the investigated training basic element;
comparing the extracted features of the investigated training basic element with the predicted features of the investigated training basic element; and
adjusting the weights of the descriptive language model based on the comparison.

14. The system of claim 10, wherein the descriptive language model is a neural network.

15. The system of claim 14, wherein the processor is configured to compare the predicted features to the real features by a second neural network.

16. The system of claim 15, wherein the processor is configured to generate a training dataset to the second neural network by:
obtaining a training text in a same language as the analyzed text, wherein the training text includes a plurality of training basic elements;
automatically labeling each of the training basic elements, together with the training basic elements coming immediately before and/or after the basic element, as being a true sample;
inserting a mistake to at least one selected basic element; and
labeling the at least one selected basic element, together with the training basic elements coming immediately before and/or after the selected basic element, as a false sample.

17. The system of claim 16, wherein the processor is configured to train the second neural network by:
extracting features of an investigated training basic element of the plurality of training basic elements and of training basic elements that come immediately before and/or after the investigated training basic element in the training text;
providing the features of the training basic elements that come immediately before and/or after the investigated training basic element to the descriptive language model to generate predicted features of the investigated training basic element;
providing the predicted features and the extracted features of the investigated training basic element to the second neural network to generate predicted score of the investigated training basic element;
comparing the predicted score with the label of the investigated training basic element; and
adjusting the weights of the second neural network based on the comparison.

18. The system of claim 10, wherein the processor is configured to:
provide a second type of features of the linguistical basic elements, to a second descriptive language model, wherein the other descriptive language model is trained to predict the second type of features of the linguistical basic element based on the second type features of the linguistical basic elements;
compare the predicted second type of features to a real second type of features of the examined basic element; and
unify the results of the comparisons to detect an anomaly in the examined basic element.
